(19) United States
(12) Patent Application Publication
(10) Pub. No.: US 2025/0189663 A1
(43) Pub. Date: Jun. 12, 2025

(54) Apparatus for Controlling Vehicle and Method Thereof

(71) Applicants: Hyundai Motor Company, Seoul (KR); Kia Corporation, Seoul (KR); UIF (University Industry Foundation),Yonsei University, Seoul (KR)

(72) Inventors: Seong Hwan Kim, Seoul (KR); Jongeun Choi, Seoul (KR); Taek Hyung Cho, Seoul (KR)

(21) Appl. No.: 18/779,757

(22) Filed: Jul. 22, 2024

(30) Foreign Application Priority Data
Dec. 8, 2023 (KR) 10-2023-0178078

(51) Int. Cl. G01S 13/931; G01S 13/86; G01S 17/89; G01S 17/931; G06T 7/50; G06T 7/70; G06V 10/77; G06V 10/774; G06V 10/80; G06V 10/82; G06V 20/56

(52) U.S. Cl. CPC G01S 13/931; G01S 13/865; G01S 13/867; G01S 17/89; G01S 17/931; G06T 7/50; G06T 7/70; G06V 10/7715; G06V 10/774; G06V 10/82; G06V 20/56; G06T 2207/10028; G06T 2207/20081; G06T 2207/20084; G06T 2207/30252; G06V 10/80

(57) ABSTRACT

A vehicle control apparatus may comprise sensors obtaining raw data identifying an external object, stored neural network models, decoders, and a processor. The processor may analyze the raw data from each sensor for predicting object locations and type using neural network models and decoders. The processor may select input data based on a distance between the object locations and reliability values and enter the selected input data into an additional neural network model of the neural network models. The processor may output, based on the input data entered into the additional neural network model, data comprising a final object location or type, and control, based on the output data, operation of the vehicle.

### CROSS-REFERENCE TO RELATED APPLICATION

This application claims the benefit of priority to Korean Patent Application No. 10-2023-0178078, filed in the Korean Intellectual Property Office on Dec. 8, 2023, the entire contents of which are incorporated herein by reference.

### TECHNICAL FIELD

The present disclosure relates to an apparatus for controlling a vehicle and a method thereof, and more specifically, relates to a technology for identifying an external object based on pieces of sensor data.

### BACKGROUND

Various studies are being conducted to identify an external object by using various sensors to assist the driving of a vehicle.

In particular, while the vehicle is driving in a driving assistance device activation mode or an autonomous driving mode, the external object may be identified by using various sensors (e.g., a LiDAR, a camera, or RADAR).

The external object may be identified by fusing pieces of sensor data obtained through the sensors if the external object is identified by using the various sensors.

### SUMMARY

According to the present disclosure, an apparatus for controlling a vehicle, the apparatus may comprise a first sensor configured to obtain, based on identifying an external object, first raw data, a second sensor configured to obtain, based on identifying the external object, second raw data, a third sensor configured to obtain, based on identifying the external object, third raw data, a memory configured to store a plurality of neural network models and a plurality of decoders, and a processor configured to obtain, based on entering the first raw data into a first neural network model of the plurality of neural network models, first sensor data associated with at least one of a location of the external object or a type of the external object, obtain, based on entering the second raw data into a second neural network model of the plurality of neural network models, second sensor data associated with at least one of the location of the external object or the type of the external object, obtain, based on entering the third raw data into a third neural network model of the plurality of neural network models, third sensor data associated with at least one of the location of the external object or the type of the external object, obtain, based on entering the first sensor data and the second sensor data into a first decoder of the plurality of decoders, first object data for predicting at least one of a first location of the external object or the type of the external object, obtain, based on entering the second sensor data and the third sensor data into a second decoder of the plurality of decoders, second object data for predicting at least one of a second location of the external object or the type of the external object, select at least one of the first object data or the second object data as input data, based on at least one of a distance between the first location and the second location, a first reliability value of the first object data, or a second reliability value of the second object data, wherein the input data is entered into a fourth neural network model of the plurality of neural network models, output, based on entering the input data into the fourth neural network model, data including at least one of a final location of the external object or a final type of the external object, and control, based on the data, operation of the vehicle.

The apparatus, wherein the first sensor data is obtained based on feature map sampling being performed on a cluster of points, wherein the cluster of points is obtained through the first sensor, and wherein the first sensor may comprise a light detection and ranging (LiDAR) device.

The apparatus, wherein the second sensor data is obtained based on feature map sampling being performed on pixels included in an image, wherein the image is obtained through the second sensor, and wherein the second sensor may comprise a camera.

The apparatus, wherein the third sensor data is obtained based on feature map sampling performed on optical signals, wherein the optical signals are obtained through the third sensor, and wherein the third sensor may comprise a radio detection and ranging (RADAR) device.

The apparatus, wherein the processor is configured to determine, based on obtaining the first raw data, a first maximum distance between a first cluster of points and the first sensor, wherein the first raw data may comprise the first cluster of points, and obtain a second intensity value in a foggy state based on at least one of the first maximum distance between the first cluster of points and the first sensor, a weight indicating the foggy state, or a first intensity value in a clear state.

The apparatus, wherein the processor is configured to determine, based on the weight indicating the foggy state, a second maximum distance that the first sensor is capable of identifying the external object in the foggy state, determine, based on the second maximum distance, the weight, and the first intensity value, a third intensity value indicating a degree of scattering by fog, obtain, based on the first cluster of points, the first maximum distance, and the second maximum distance, a second cluster of points scattered by the fog, and train, based on the second cluster of points, at least one of the plurality of neural network models.

The apparatus, wherein the second raw data includes a light permeability, an airglow, and first pixel values for forming an image obtained through the second sensor, and wherein the processor is configured to generate, based on the light permeability, the airglow, and the first pixel values, second pixel values associated with an image in a foggy state, and train, based on a virtual image formed by the second pixel values, at least one of the plurality of neural network models.

The apparatus, wherein the processor is configured to obtain, based on a depth map pixel value and a weight indicating the foggy state, the light permeability.

The apparatus, wherein the processor is configured to select, based on whether the first reliability value and the second reliability value exceed a reference reliability value, at least one of the first object data or the second object data as the input data.

The apparatus, wherein the processor is configured to determine the first location, wherein the first location is generated by the first object data and the first location indicates a center point of a first bounding box corresponding to the external object, determine the second location, wherein the second location is generated by the second object data and the second location indicates a center point of a second bounding box corresponding to the external object, and select, based on whether the distance between the first location and the second location exceeds a reference distance, at least one of the first object data or the second object data as the input data.

According to the present disclosure, a method performed by a processor for controlling a vehicle, the method comprising obtaining, based on entering a first raw data into a first neural network model of a plurality of neural network models stored in a memory, first sensor data associated with at least one of a location of an external object or a type of the external object, wherein the first raw data is obtained based on identifying the external object through a first sensor, obtaining, based on entering the second raw data into a second neural network model of the plurality of neural network models, second sensor data associated with at least one of the location of the external object or the type of the external object, wherein the second raw data is obtained based on identifying the external object through a second sensor, obtaining, based on entering the third raw data into a third neural network model of the plurality of neural network models, third sensor data associated with at least one of the location of the external object or the type of the external object, wherein the third raw data is obtained based on identifying the external object through a third sensor, obtaining, based on entering the first sensor data and the second sensor data into a first decoder of the plurality of decoders, first object data for predicting at least one of a first location of the external object or the type of the external object, obtaining, based on entering the second sensor data and the third sensor data into a second decoder of the plurality of decoders, second object data for predicting at least one of a second location of the external object or the type of the external object, selecting at least one of the first object data or the second object data as input data, based on at least one of a distance between the first location and the second location, a first reliability value of the first object data, or a second reliability value of the second object data, wherein the input data is entered into a fourth neural network model of the plurality of neural network models, and outputting, based on entering the input data into the fourth neural network model, data including at least one of a final location of the external object or a final type of the external object, and controlling, based on the data, operation of the vehicle.

The method, wherein the first sensor data is obtained based on feature map sampling being performed on a cluster of points, wherein the cluster of points is obtained through the first sensor, and wherein the first sensor may comprise a light detection and ranging (LiDAR) device.

The method, wherein the second sensor data is obtained based on feature map sampling being performed on pixels of an image, wherein the image is obtained through the second sensor, and wherein the second sensor may comprise a camera.

The method, wherein the third sensor data is obtained based on feature map sampling performed on optical signals, wherein the optical signals are obtained through the third sensor, and wherein the third sensor may comprise a radio detection and ranging (RADAR) device.

The method may further comprise determining, based on obtaining the first raw data, a first maximum distance between a first cluster of points and the first sensor, wherein the first raw data may comprise the first cluster of points, and obtaining a second intensity value in a foggy state based on at least one of the first maximum distance between the first cluster of points and the first sensor, a weight indicating the foggy state, or a first intensity value in a clear state.

The method may further comprise determining, based on the weight indicating the foggy state, a second maximum distance that the first sensor is capable of identifying the external object in the foggy state, determining, based on the second maximum distance, the weight, and the first intensity value, a third intensity value indicating a degree of scattering by fog, obtaining, based on the first cluster of points, the first maximum distance, and the second maximum distance, a second cluster of points scattered by the fog, and training, based on the second cluster of points, at least one of the plurality of neural network models.

The method, wherein the second raw data includes a light permeability, an airglow, and first pixel values for forming an image obtained through the second sensor, and the method further comprising generating, based on the light permeability, the airglow, and the first pixel values, second pixel values associated with an image in a foggy state, and training, based on a virtual image formed by the second pixel values, at least one of the plurality of neural network models.

The method may further comprise obtaining, based on a depth map pixel value and a weight indicating the foggy state, the light permeability.

The method may further comprise selecting, based on whether the first reliability value and the second reliability value exceed a reference reliability value, at least one of the first object data or the second object data.

The method may further comprise determining the first location, wherein the first location is generated by the first object data and the first location indicates a center point of a first bounding box corresponding to the external object, determining the second location, wherein the second location is generated by the second object data and the second location indicates a center point of a second bounding box corresponding to the external object, and selecting, based on whether the distance between the first location and the second location exceeds a reference distance, at least one of the first object data or the second object data.

### BRIEF DESCRIPTION OF THE DRAWINGS

The above and other objects, features and advantages of the present disclosure will be more apparent from the following detailed description taken in conjunction with the accompanying drawings:

FIG. 1 shows an example of a block diagram associated with a vehicle control apparatus, according to an example of the present disclosure;

FIG. 2 shows an example associated with a plurality of neural network models, in an example of the present disclosure;

FIG. 3 shows an example of a flowchart associated with a vehicle control method, according to an example of the present disclosure;

FIG. 4 shows an example in which a vehicle control apparatus processes raw data, according to an example of the present disclosure;

FIG. 5 shows an example of obtaining virtual data for training at least one of a plurality of neural network models, in an example of the present disclosure;

FIG. 6 shows an example of identifying or determining an external object by using hardware components included in a vehicle control apparatus, according to an example of the present disclosure;

FIG. 7 shows an example of first object data and second object data, in an example of the present disclosure;

FIG. 8 shows an example of removing data with relatively low reliability, in an example of the present disclosure;

FIG. 9 shows an example of obtaining output data, in an example of the present disclosure;

FIG. 10 shows an example of outputting output data, in an example of the present disclosure;

FIG. 11 shows an example associated with a flowchart of a vehicle control method, according to an example of the present disclosure;

FIG. 12 shows an example of a process using a distance between center points of bounding boxes, or an area in which bounding boxes overlap each other, in an example of the present disclosure;

FIG. 13 shows an example of creating a bounding box corresponding to an external object by using data of a first time point and data of a second time point before the first time point, in an example of the present disclosure;

FIG. 14 shows an example of a flowchart associated with a vehicle control method, according to an example of the present disclosure; and

FIG. 15 shows a computing system associated with a vehicle control apparatus or vehicle control method, according to an example of the present disclosure.

### DETAILED DESCRIPTION

Hereinafter, some examples of the present disclosure will be described in detail with reference to the accompanying drawings. In adding reference numerals to components of each drawing, it should be noted that the same components include the same reference numerals, although they are indicated on another drawing. Furthermore, in describing the examples of the present disclosure, detailed descriptions associated with well-known functions or configurations will be omitted if they may make subject matters of the present disclosure unnecessarily obscure.

In describing elements of an example of the present disclosure, the terms first, second, A, B, (a), (b), and the like may be used herein. These terms are only used to distinguish one element from another element, but do not limit the corresponding elements irrespective of the nature, order, or priority of the corresponding elements. Furthermore, unless otherwise defined, all terms including technical and scientific terms used herein are to be interpreted as is customary in the art to which the present disclosure belongs. It will be understood that terms used herein should be interpreted as including a meaning that is consistent with their meaning in the context of the present disclosure and the relevant art and will not be interpreted in an idealized or overly formal sense unless expressly so defined herein.

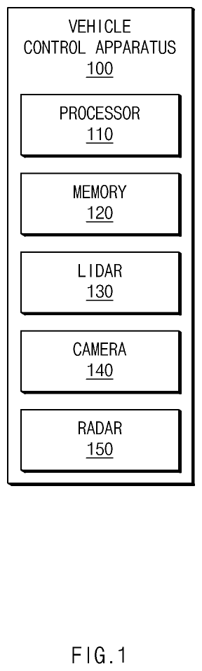

Hereinafter, various examples of the present disclosure will be described in detail with reference to FIGS. 1 to 15.

FIG. 1 shows an example of a block diagram associated with a vehicle control apparatus, according to an example of the present disclosure.

Referring to FIG. 1, a vehicle control apparatus 100 according to an example of the present disclosure may be implemented inside or outside a vehicle, and some of components included in the vehicle control apparatus 100 may be implemented inside or outside the vehicle. At this time, the vehicle control apparatus 100 may be integrated with internal control units of a vehicle and may be implemented with a separate device so as to be coupled with control units of the vehicle by means of a separate connection means. For example, the vehicle control apparatus 100 may further include components not shown in FIG. 1.

The vehicle control apparatus 100 according to an example may include a processor 110, a memory 120, a LiDAR 130, a camera 140, and RADAR 150. The processor 110, the memory 120, the LiDAR 130, the camera 140, or the RADAR 150 may be electrically and/or operably coupled with each other by an electronic component including a communication bus.

Hereinafter, the fact that pieces of hardware are coupled operably may include the fact that a direct and/or indirect connection between the pieces of hardware is established by wired and/or wirelessly such that second hardware is controlled by first hardware among the pieces of hardware.

Although different blocks are shown, an example is not limited thereto. For example, some of the pieces of hardware in FIG. 1 may be included in a single integrated circuit including a system on a chip (SoC). The type and/or number of hardware included in the vehicle control apparatus 100 is not limited to that shown in FIG. 1. For example, the vehicle control apparatus 100 may include all or only some of the pieces of hardware shown in FIG. 1.

The vehicle control apparatus 100 according to an example may include hardware for processing data based on one or more instructions. The hardware for processing data may include the processor 110.

For example, the hardware for processing data may include an arithmetic and logic unit (ALU), a floating point unit (FPU), a field programmable gate array (FPGA), a central processing unit (CPU), and/or an application processor (AP). The processor 110 may include a structure of a single-core processor, or may include a structure of a multi-core processor including a dual core, a quad core, a hexa core, or an octa core.

The memory 120 of the vehicle control apparatus 100 according to an example may include a hardware component for storing data and/or instructions that are to be input and/or output to the processor 110 of the vehicle control apparatus 100. For example, the memory 120 may include a volatile memory including a random-access memory (RAM), and/or a non-volatile memory including a read-only memory (ROM).

For example, the volatile memory may include at least one of a dynamic RAM (DRAM), a static RAM (SRAM), a cache RAM, or a pseudo SRAM (PSRAM), or any combination thereof.

For example, the non-volatile memory includes at least one of a programmable ROM (PROM), an erasable PROM (EPROM), an electrically erasable PROM (EEPROM), a flash memory, a hard disk, a compact disk, a solid state drive (SSD), or an embedded multi-media card (eMMC), or any combination thereof.

In an example, the memory 120 may store a plurality of neural network models, and/or a plurality of decoders. The memory 120 may include a plurality of neural network models and/or a plurality of decoders.

For example, the plurality of decoders may include neural network models different from the plurality of neural network models described above.

The LiDAR 130 included in the vehicle control apparatus 100 according to an example may obtain data sets from identifying an object surrounding the vehicle control apparatus 100. For example, the LiDAR 130 may identify or determine at least one of a location of the surrounding object, a movement direction of the surrounding object, or a speed of the surrounding object, or any combination thereof based on a pulse laser signal emitted from the LiDAR 130 being reflected by the surrounding object and returned.

For example, the LiDAR 130 may obtain data sets for expressing an external object in the space defined by a first axis, a second axis, and a third axis based on a pulse laser signal reflected from surrounding objects. For example, the LiDAR 130 may obtain data sets including a plurality of points in the space, which is formed by the first axis, the second axis, and the third axis, based on receiving the pulse laser signal at a specified period. For example, the first axis may include the x-axis. For example, the second axis may include the y-axis. For example, the third axis may include the z-axis. For example, the first axis, the second axis, and the third axis may be perpendicular to each other and may intersect each other based on an origin point. The first axis, the second axis, and the third axis are not limited to the above examples. Hereinafter, for convenience of description, the first axis is described as the x-axis; the second axis is described as the y-axis; and the third axis is described as the z-axis.

The processor 110 included in the vehicle control apparatus 100 according to an example may emit light from a vehicle by using the LiDAR 130. For example, the processor 110 may receive light emitted from the vehicle. For example, the processor 110 may identify at least one of a location, a speed, or a moving direction, or any combination thereof of a surrounding object based on a time taken or required to transmit light emitted from the vehicle and a time taken or required to receive light emitted from the vehicle.

For example, the processor 110 may obtain data sets including a plurality of points based on the time taken or taken or required to transmit light emitted from the vehicle and the time taken or required to receive light emitted from the vehicle. The processor 110 may obtain data sets for expressing a plurality of points in a three-dimensional virtual coordinate system including the x-axis, the y-axis, and the z-axis.

For example, the LiDAR 130 may identify an external object. The LiDAR 130 may obtain first raw data including points corresponding to the external object and/or a point cloud corresponding to the external object, based on identifying the external object.

The camera 140 included in the vehicle control apparatus 100 according to an example may include one or more optical sensors (e.g., a charged coupled device (CCD) sensor and/or a complementary metal oxide semiconductor (CMOS) sensor) that generate electrical signals indicating the color and/or brightness of light. Each of a plurality of optical sensors included in the camera 140 may be arranged in a form of a 2-dimensional array.

For example, the camera 140 may obtain electrical signals from a plurality of optical sensors substantially simultaneously and may generate images and/or frames, each of which correspond to light reaching the 2-dimensional array of optical sensors and each of which include a plurality of pixels arranged in two dimensions.

For example, photo data captured by using the camera 140 may refer to a plurality of images obtained from the camera 140.

For example, video data captured by using the camera 140 may mean the sequence of a plurality of images obtained from the camera 140 at a specified frame rate.

In an example, the camera 140 may obtain second raw data including an image representing an external object, based on identifying the external object.

The RADAR 150 included in the vehicle control apparatus 100 according to an example may include a long range RADAR (LRR), and/or a short range RADAR (SRR). For example, the RADAR 150 may identify the speed of a surrounding object and a distance between the RADAR 150 and the surrounding object by outputting electromagnetic waves and measuring the time and frequency shift of electromagnetic waves reflected from the surrounding object.

In an example, the RADAR 150 may obtain third raw data based on identifying the external object.

The processor 110 of the vehicle control apparatus 100 according to an example may enter the first raw data into a first neural network model included in the plurality of neural network models. The processor 110 may obtain first sensor data associated with at least one of a location of the external object, or the type of the external object, or any combination thereof based on entering the first raw data into the first neural network model.

For example, the first sensor data may be obtained based on the fact that feature map sampling is performed on a point cloud obtained through the LiDAR 130. For example, the processor 110 may obtain the first sensor data, which is obtained by performing feature map sampling on the point cloud, based on entering the first raw data into the first neural network model.

In an example, the processor 110 may obtain second sensor data associated with at least one of a location of the external object, or the type of the external object, or any combination thereof based on entering the second raw data into a second neural network model included in the plurality of neural network models.

For example, the second sensor data may be obtained based on feature map sampling being performed on pixels included in the image obtained through the camera 140. For example, the processor 110 may obtain the second sensor data, which is obtained by performing feature map sampling on pixels included in the image, based on entering the second raw data into the second neural network model. For example, the second neural network model may include ResNet-101.

In an example, the processor 110 may obtain third sensor data associated with at least one of a location of the external object, or the type of the external object, or any combination thereof based on entering the third raw data into a third neural network model included in the plurality of neural network models.

For example, the third sensor data may be obtained based on the fact that the feature map sampling is performed on optical signals obtained through the RADAR 150. For example, the processor 110 may obtain third sensor data, which is obtained by performing feature map sampling on optical signals, based on entering the third raw data into the third neural network model. For example, the third neural network model may include a multi-layer perceptron (MLP).

In an example, the processor 110 may enter the first sensor data and the second sensor data into a first decoder included in the plurality of decoders. The processor 110 may obtain first object data for predicting at least one of a first location of the external object, or the type of the external object, or any combination thereof based on entering the first sensor data and the second sensor data into the first decoder.

In an example, the processor 110 may enter the second sensor data and the third sensor data into a second decoder included in the plurality of decoders. The processor 110 may obtain second object data for predicting at least one of a second location of the external object, or the type of the external object, or any combination thereof based on entering the second sensor data and the third sensor data into the second decoder.

In an example, the processor 110 may select at least one of the first object data, or the second object data, or any combination thereof as input data to be entered into a fourth neural network model included in the plurality of neural network models, based on at least one of a distance between the first location and the second location, first reliability of the first object data, or second reliability of the second object data, or any combination thereof. For example, the fourth neural network model may include an ensemble-based meta model.

In an example, the processor 110 may output output data including at least one of a final location of the external object, or a final type of the external object, or any combination thereof based on the fact that input data is entered into the fourth neural network model.

In an example, the processor 110 may obtain first raw data including the first point cloud through the LiDAR 130. For example, the processor 110 may identify a first maximum distance between a first point cloud and the LiDAR 130 based on obtaining the first raw data including the first point cloud through the LiDAR 130. The processor 110 may obtain a second intensity value in a foggy state based on at least one of the first maximum distance between the first point cloud and the LiDAR 130, a weight indicating the degree of fog, or a first intensity value in a clear state, or any combination thereof.

For example, the processor 110 may identify a second maximum distance of the LiDAR 130 capable of identifying an external object in a foggy state based on the weight indicating the foggy state. The processor 110 may identify a third intensity value indicating the degree of scattering by fog based on the second maximum distance, the weight indicating a foggy state, and the first intensity value in a clear state. For example, the intensity value may include a parameter associated with the brightness of an image.

In an example, the processor 110 may obtain a second point cloud scattered by fog based on the first point cloud, the second maximum distance, and the first maximum distance.

According to an example, the processor 110 may obtain the second point cloud scattered by fog based on at least one of the first point cloud, the second maximum distance, the first intensity value, the second intensity value, or the third intensity value, or any combination thereof.

In an example, the processor 110 may train at least one of the plurality of neural network models by using the second point cloud.

In an example, the second raw data obtained by the camera 140 may include a light permeability, an airglow, and first pixel values for forming an image obtained through the camera 140.

In an example, the processor 110 may generate the second pixel values associated with the image in a foggy state based on the light permeability, the airglow, and the first pixel values. According to an example, the processor 110 may generate the second pixel values associated with the image in the foggy state based on at least one of the light permeability, the airglow, or the first pixel values, or any combination thereof.

In an example, the processor 110 may train at least one of the plurality of neural network models by using the virtual image formed by the second pixel values.

In an example, the processor 110 may obtain the light permeability based on a depth map pixel value and a weight indicating a foggy state.

In an example, the processor 110 may select at least one of the first object data, or the second object data, or any combination thereof as input data based on whether the first reliability and the second reliability exceed reference reliability.

In an example, the processor 110 may identify a first bounding box generated by the first object data. For example, the processor 110 may identify a first location, which is generated by the first object data and which indicates a center point of the first bounding box corresponding to the external object.

In an example, the processor 110 may identify a second bounding box generated by the second object data. For example, the processor 110 may identify a second location, which is generated by the second object data and which indicates a center point of the second bounding box corresponding to the external object.

In an example, the processor 110 may identify a distance between the first location and the second location. The processor 110 may select at least one of the first object data, or the second object data, or any combination thereof as input data based on whether the distance between the first location and the second location exceeds the reference distance.

In an example, the processor 110 may select at least one of the first object data, or the second object data, or any combination thereof as input data based on at least one of the first object data, or the second object data, or any combination thereof selected as input data.

In an example, the processor 110 may identify the second reliability of the second object data based on the first reliability of the first object data exceeding the reference reliability. The processor 110 may select the first object data and the second object data as input data based on the second reliability of the second object data exceeding the reference reliability. The processor 110 may select the first object data as input data based on the fact that the second reliability of the second object data is smaller than or equal to the reference reliability.

In an example, the processor 110 may identify the second reliability of the second object data based on the fact that the first reliability of the first object data is smaller than or equal to the reference reliability. The processor 110 may select the second object data as input data based on the second reliability of the second object data exceeding the reference reliability. On the basis of the fact that the second reliability of the second object data is smaller than or equal to the reference reliability, the processor 110 may remove the first object data and the second object data and may select third object data, which is different from the above-described first object data and second object data, as input data. For example, the third object data may be generated based on raw data obtained by sensors different from the LiDAR 130, the camera 140, and the RADAR 150.

In an example, the processor 110 may identify a first location, which is generated by the first object data and which indicates the center point of the first bounding box corresponding to the external object. The processor 110 may identify a second location, which is generated by the second object data and which indicates the center point of the second bounding box corresponding to the external object. The processor 110 may identify a distance between the first location and the second location. The processor 110 may determine whether the distance between the first location and the second location exceeds a reference distance.

In an example, the processor 110 may remove the first object data and the second object data based on the distance between the first location and the second location exceeding the reference distance. On the basis of the distance between the first location and the second location exceeding the reference distance, the processor 110 may remove first object data and second object data and may select the third object data, which is different from the first object data and second object data, as input data.

In an example, the processor 110 may identify that the distance between the first location and the second location is smaller than or equal to the reference distance. The processor 110 may determine whether the first reliability of the first object data and the second reliability of the second object data exceed the reference reliability, based on the distance between the first location and the second location being smaller than or equal to the reference distance.

In an example, the processor 110 may identify the first bounding box, which is generated by the first object data and which corresponds to the external object. The processor 110 may identify the second bounding box, which is generated by the second object data and which corresponds to the external object.

For example, the processor 110 may identify an area where the first bounding box overlaps the second bounding box. The processor 110 may train at least one of the plurality of neural network models based on the area where the first bounding box overlaps the second bounding box. For example, the processor 110 may select at least one of the first object data, or the second object data, or any combination thereof as input data based on the area where the first bounding box overlaps the second bounding box.

As described above, the processor 110 of the vehicle control apparatus 100 according to an example may accurately detect an external object by identifying the external object based on raw data obtained through a plurality of sensors (e.g., the LiDAR 130, the camera 140, and/or the RADAR 150).

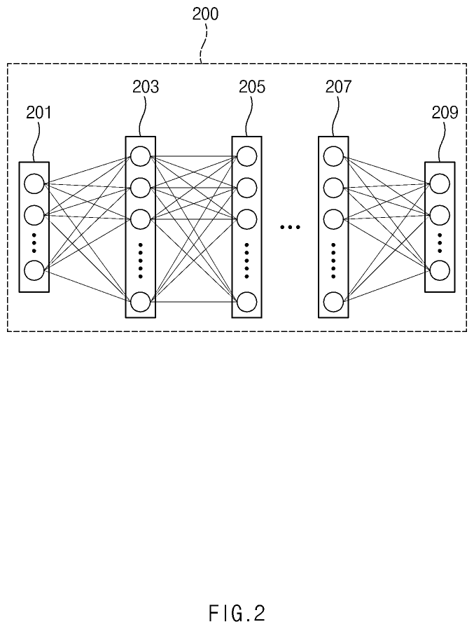

FIG. 2 shows an example associated with a plurality of neural network models, in an example of the present disclosure.

Referring to FIG. 2, a memory (e.g., the memory 120 in FIG. 1) of a vehicle control apparatus (e.g., the vehicle control apparatus 100 in FIG. 1) according to an example may store a plurality of neural network models (e.g., Convolutional Neural Networks (CNNs), Recurrent Neural Networks (RNNs), Generative Adversarial Networks (GANs), Perceptron, Multilayer Perceptrons (MLPs) etc.) and a plurality of decoders. Hereinafter, a neural network model 200 may include the plurality of neural network models and/or the plurality of decoders.

In an example, the neural network model 200 may include an input layer 201, hidden layers 203, 205, and 207, and an output layer 209. For example, the input layer 201 may include input neurons. For example, each of the hidden layers 203, 205, and 207 may include hidden neurons. For example, the output layer 209 may include output neurons.

For example, at least one of the input neurons, the hidden neurons, or the output neurons, or any combination thereof may be changed by a user.

For example, the neural network model 200 may include a loss function. For example, the neural network model may include a cost function. For example, the loss function and the cost function may be substantially the same as each other.

For example, the loss function may be used to minimize the normalization of the bounding box. For example, the loss function may be used to minimize cross-entropy.

For example, the processor (e.g., the processor 110 in FIG. 1) may train the neural network model 200. For example, the processor may train the neural network model 200 based on input data selected from at least one of the first object data, or the second object data, or any combination thereof. For example, the processor may train the neural network model 200 based on at least one of input data, output data obtained by the neural network model 200, the loss function, or a ground-truth, or any combination thereof.

For example, the ground-truth may include actual information corresponding to training data for training the neural network model 200. For example, the actual information may include at least one of actual location information of an external object included in the training data for training the neural network model 200, or classification information of the above-described external object, or any combination thereof.

As described above, the processor of the vehicle control apparatus according to an example may train the neural network model 200 by using various parameters. The processor may obtain output data with relatively accurate location and size by obtaining the output data corresponding to the external object by using the neural network model 200 based on training the neural network model 200 by using various parameters.

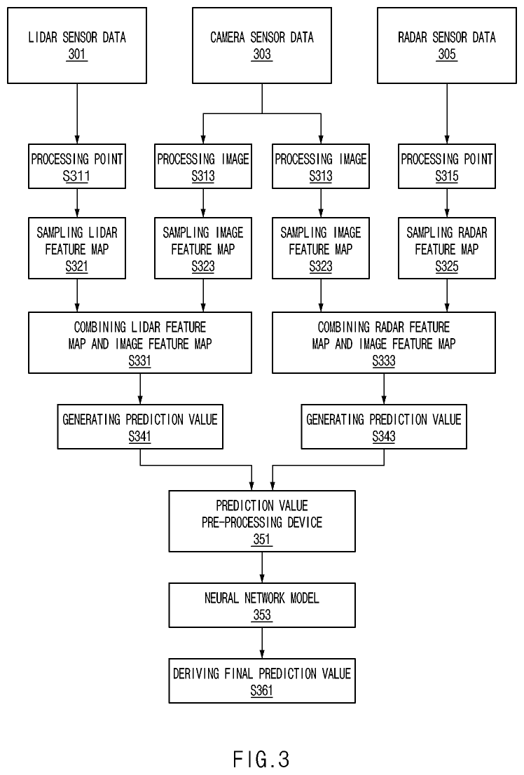

FIG. 3 shows an example of a flowchart associated with a vehicle control method, according to an example of the present disclosure.

Referring to FIG. 3, a vehicle control method according to an example may include an operation of obtaining first sensor data (e.g., a LiDAR sensor data 301) through a first sensor (e.g., the LiDAR 130 in FIG. 1). The vehicle control method may include an operation of obtaining second sensor data (e.g., camera sensor data 303) through a second sensor (e.g., the camera 140 in FIG. 1). The vehicle control method may include an operation of obtaining third sensor data (e.g., RADAR sensor data 305) through a third sensor (e.g., the RADAR 150 in FIG. 1).

For example, the LiDAR sensor data 301 may be referred to as first raw data obtained through the LiDAR described in FIG. 1. For example, the camera sensor data 303 may be referred to as second raw data obtained through the camera described in FIG. 1. For example, the RADAR sensor data 305 may be referred to as third raw data obtained through RADAR described in FIG. 1.

In operation S311, the vehicle control method according to an example may include an operation of performing point processing on the LiDAR sensor data 301. For example, the operation of performing point processing on the LiDAR sensor data 301 may include an operation of setting points obtained by the LiDAR as a cluster of points (e.g., a point cloud).

In operation S313, the vehicle control method according to an example may include an operation of performing image processing on the camera sensor data 303. For example, the operation of performing image processing on the camera sensor data 303 may include an operation of analyzing pixel values included in an image obtained by the camera.

In operation S315, the vehicle control method according to an example may include an operation of performing point processing on the RADAR sensor data 305. For example, the operation of performing the point processing on the RADAR sensor data 305 may include an operation of performing signal processing of points obtained by the RADAR.

In operation S321, the vehicle control method according to an example may include an operation of performing LiDAR feature map sampling. For example, the operation of performing the LiDAR feature map sampling may be substantially the same as an operation of obtaining first sensor data based on entering the point-processed LiDAR sensor data 301 into the first neural network model described in FIG. 1.

In operation S323, the vehicle control method according to an example may include an operation of performing image feature map sampling. For example, the operation of performing the image feature map sampling may be substantially the same as an operation of obtaining second sensor data based on entering the image-processed camera sensor data 303 into the second neural network model described in FIG. 1.

In operation S325, the vehicle control method according to an example may include an operation of performing RADAR feature map sampling. For example, the operation of performing the RADAR feature map sampling may be substantially the same as an operation of obtaining third sensor data based on entering the point-processed RADAR sensor data 305 into the third neural network model described in FIG. 1.

In operation S331, the vehicle control method according to an example may include an operation of combining the LiDAR feature map and the image feature map. For example, the operation of combining the LiDAR feature map and the image feature map may include an operation of entering the LiDAR feature map and the image feature map into a first decoder among a plurality of decoders stored in a memory.

In operation S333, the vehicle control method according to an example may include an operation of combining the RADAR feature map and the image feature map. For example, the operation of combining the RADAR feature map and the image feature map may include an operation of entering the RADAR feature map and the image feature map into a second decoder among the plurality of decoders stored in the memory.

In operation S341, the vehicle control method according to an example may include an operation of generating a first prediction value. For example, the first prediction value may include at least one of the first location of the external object, or the type of the external object, or any combination thereof based on combining the LiDAR feature map and the image feature map.

In operation S343, the vehicle control method according to an example may include an operation of generating a second prediction value. For example, the second prediction value may include at least one of the second location of the external object, or the type of the external object, or any combination thereof based on combining the RADAR feature map and the image feature map.

The vehicle control method according to an example may include an operation of entering the first prediction value and the second prediction value into a prediction value pre-processing device 351. For example, the prediction value pre-processing device 351 may perform a process of selecting input data to be entered into a neural network model 353 based on a distance between the first location included in the first prediction value and the second location included in the second prediction value. For example, the prediction value pre-processing device 351 may perform a process of selecting input data to be enter into the neural network model 353 based on the first reliability of the first prediction value and the second reliability of the second prediction value.

The above-described first prediction value may refer to the first object data described in FIG. 1. The above-described second prediction value may refer to the second object data described in FIG. 1.

The vehicle control method according to an example may select input data to be entered into the neural network model 353 from among at least one of the first prediction value, or the second prediction value, or any combination thereof through the prediction value pre-processing device 351. For example, the neural network model 353 may include the fourth neural network model described in FIG. 1.

In operation S361, the vehicle control method according to an example may include an operation of deriving a final prediction value from the neural network model 353. For example, the final prediction value may include at least one of a final location of the external object, or a final type of the external object, or any combination thereof.

As mentioned above, the vehicle control method according to an example may accurately identify at least one of the final location of the external object, or the final type of the external object, or any combination thereof by identifying at least one of the final location of the external object, or the final type of the external object, or any combination thereof based on entering pieces of sensor data obtained by a plurality of sensors into the plurality of neural network models.

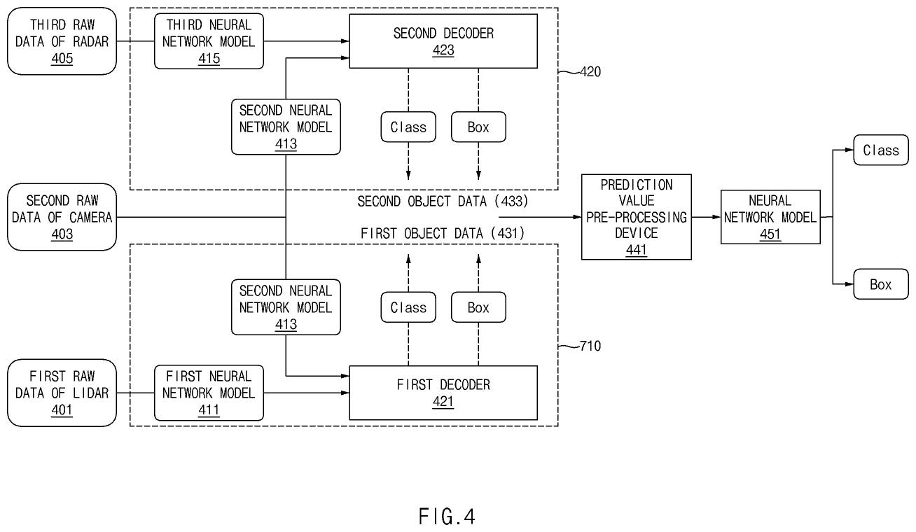

FIG. 4 shows an example in which a vehicle control apparatus processes raw data, according to an example of the present disclosure.

Referring to FIG. 4, a processor (e.g., the processor 110 in FIG. 1) of a vehicle control apparatus (e.g., the vehicle control apparatus 100 in FIG. 1) according to an example may obtain first raw data 401 through a first sensor (e.g., the LiDAR 130 in FIG. 1). The processor may obtain second raw data 403 through a second sensor (e.g., the camera 140 in FIG. 1). The processor may obtain third raw data 405 of through a third sensor (e.g., the RADAR 150 in FIG. 1). Hereinafter, for convenience of description, the first raw data 401 of LiDAR is referred to as the “first raw data” 401; the second raw data of camera is referred to as the “second raw data” 403; and, the third raw data 405 of RADAR is referred to as the “third raw data” 405.

In an example, the processor may enter the first raw data 401 into a first neural network model 411. For example, the processor may obtain first sensor data associated with at least one of the location of the external object, or the type of the external object, or any combination thereof based on entering the first raw data 401 into the first neural network model 411.

In an example, the processor may enter the second raw data 403 into a second neural network model 413. For example, the processor may obtain second sensor data associated with at least one of the location of the external object, or the type of the external object, or any combination thereof based on entering the second raw data 403 into the second neural network model 413.

In an example, the processor may enter the third raw data 405 into a third neural network model 415. For example, the processor may obtain third sensor data associated with at least one of the location of the external object, or the type of the external object, or any combination thereof based on entering the third raw data 405 into the third neural network model 415.

In an example, the processor may enter, into a first decoder 421, the first sensor data obtained from the first neural network model 411 and the second sensor data obtained from the second neural network model 413.

For example, the first decoder 421 may output the first bounding box corresponding to the external object based on the first sensor data and the second sensor data. For example, the first decoder 421 may output the type of the external object based on the first sensor data and the second sensor data.

In an example, the processor may enter, into a second decoder 423, the second sensor data obtained from the second neural network model 413 and the third sensor data obtained from the third neural network model 415.

For example, the second decoder 423 may output the second bounding box corresponding to the external object based on the second sensor data and the third sensor data. For example, the second decoder 423 may output the type of the external object based on the second sensor data and the third sensor data.

In an example, the processor may obtain first object data 431 from the first decoder 421. The processor may obtain second object data 433 from the second decoder 423. For example, the first object data 431 may include at least one of a first location of the external object, or the type of the external object, or any combination thereof, which is output from the first decoder 421. For example, the second object data 433 may include at least one of a second location of the external object, or the type of the external object, or any combination thereof, which is output from the second decoder 423.

In an example, the processor may enter the first object data 431 and the second object data 433 into a prediction value pre-processing device 441. For example, the prediction value pre-processing device 441 of FIG. 4 may include the prediction value pre-processing device 351 of FIG. 3. Accordingly, the prediction value pre-processing device 441 of FIG. 4 may perform substantially the same process as the prediction value pre-processing device 351 of FIG. 3.

In an example, the processor may select input data to be entered into a neural network model 451 based on entering the first object data 431 and the second object data 433 into the prediction value pre-processing device 441. For example, the processor may select input data to be entered into the neural network model 451 among at least one of the first object data 431, or the second object data 433, or any combination thereof.

In an example, the processor may enter input data into the neural network model 451. For example, the neural network model 451 may include the fourth neural network model described in FIG. 1. For example, the input data may be selected from at least one of the first object data 431, or the second object data 433, or any combination thereof.

In an example, the processor may output output data including at least one of a final location of the external object, or a final type of the external object, or any combination thereof based on the fact that input data is entered into the neural network model 451.

As described above, the processor of the vehicle control apparatus according to an example may enter the selected input data into the neural network model based on selecting input data among pieces of sensor data. The processor may obtain output data with relatively high reliability by identifying at least one of the final location of the external object, or the final type of the external object, or any combination thereof based on using input data with relatively high reliability.

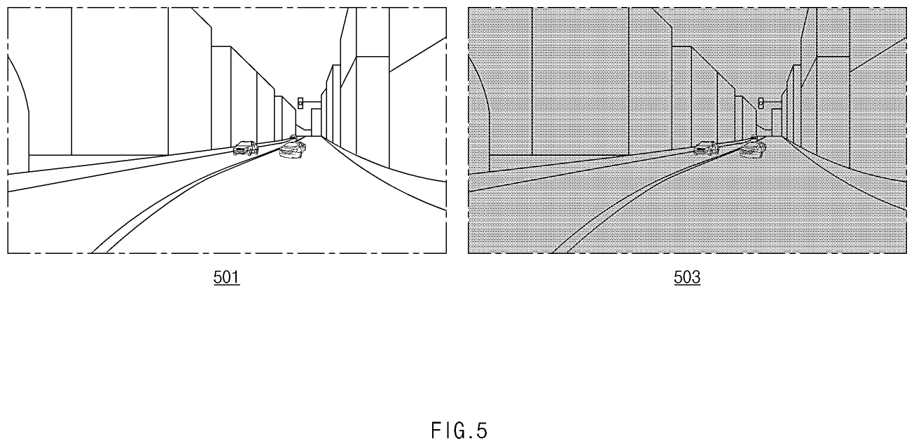

FIG. 5 shows an example of obtaining virtual data for training at least one of a plurality of neural network models, in an example of the present disclosure.

Referring to FIG. 5, a processor (e.g., the processor 110 in FIG. 1) of a vehicle control apparatus (e.g., the vehicle control apparatus 100 in FIG. 1) according to an example may obtain a point map and/or image for identifying an external object through a first sensor (e.g., the LiDAR 130 in FIG. 1), a second sensor (e.g., the camera 140 in FIG. 1), and/or a third sensor (e.g., the RADAR 150 in FIG. 1).

A first example 501 in FIG. 5 may include a point map and/or image obtained through different types of sensors (e.g., the LiDAR, the camera, and/or the RADAR). A second example 503 in FIG. 5 may include a virtual point map and/or a virtual image, which is created by processing the point map and/or the image.

In an example, the processor may identify a first maximum distance between a first cluster of points (e.g., a first point cloud) and a first sensor (e.g., the LiDAR and/or the RADAR). For example, the processor may identify a weight indicating the degree of fog. For example, the weight indicating the degree of fog may be set by a user. For example, the processor may identify a first intensity value in a clear state. For example, the first intensity value may be set by the user.

In an example, the processor may obtain a second intensity value in a foggy state based on at least one of the first maximum distance, the weight, or the first intensity value, or any combination thereof.

In an example, the processor may identify pixel values included in an image obtained through the camera. The processor may identify at least one of pixel values, a light permeability, or an airglow, or any combination thereof, which is included in the second raw data obtained through the camera.

For example, the processor may identify the light permeability based on a depth map pixel value. For example, the depth map pixel value may be maximally about 50-52 m.

For example, the processor may identify a third intensity value, which indicates the degree of scattering by fog, based on at least one of pixel values, a light permeability, or an airglow, or any combination thereof included in the second raw data.

In an example, the processor may create a virtual image based on a third intensity value indicating the degree of scattering by fog.

In an example, the processor may create a virtual point map based on the third intensity value indicating the degree of scattering by fog.

In an example, the processor may train at least one of a plurality of neural networks based on creating the virtual image and/or the virtual point map. For example, the processor may train at least one of a plurality of neural network models by using the virtual image and/or the virtual point map.

As described above, the processor of the vehicle control apparatus according to an example may accurately identify an external object in various situations by training at least one of a plurality of neural network models based on creating virtual images corresponding to the various situations.

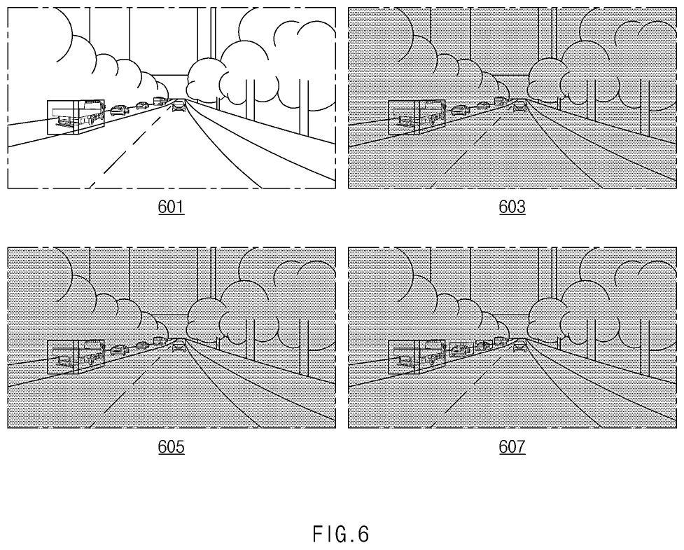

FIG. 6 shows an example of identifying an external object by using hardware components included in a vehicle control apparatus, according to an example of the present disclosure.

Referring to FIG. 6, a first example 601 in FIG. 6 may include an example of correct answer data for training a neural network model. For example, the correct answer data may be referred to as a “ground-truth”.

A second example 603 in FIG. 6 may include an example of identifying an external object based on pieces of data obtained through a first sensor (e.g., the LiDAR 130 in FIG. 1) and a second sensor (e.g., the camera 140 in FIG. 1),

A third example 605 in FIG. 6 may include an example of identifying an external object based on pieces of data obtained through different sensors, for example, the camera and RADAR (e.g., the RADAR 150 in FIG. 1).

A fourth example 607 in FIG. 6 may include an example of identifying an external object based on pieces of data obtained through the LiDAR, the camera, and the RADAR.

As shown in the first to fourth examples 601 to 607 of FIG. 6, it may be seen that the external object is identified relatively accurately if an external object is identified by using the LiDAR, the camera, and the RADAR (e.g., the fourth example 607) compared to using the LiDAR and the camera, or using the camera and the RADAR (e.g., the second example 603 or the third example 605).

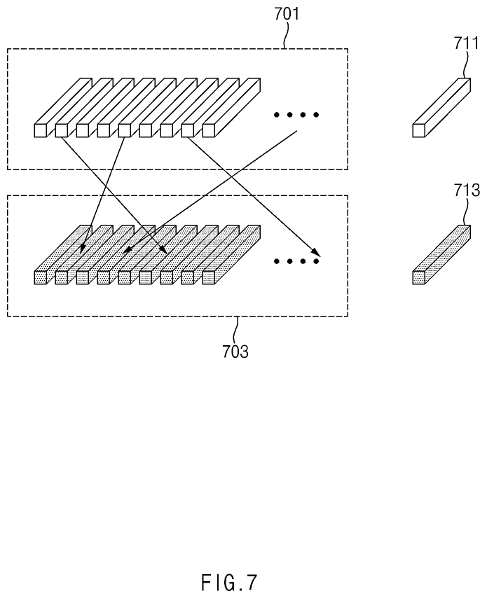

FIG. 7 shows an example of first object data and second object data, in an example of the present disclosure.

Referring to FIG. 7, a processor (e.g., the processor 110 in FIG. 1) of a vehicle control apparatus (e.g., the vehicle control apparatus 100 in FIG. 1) according to an example may obtain first raw data through a first sensor (e.g., the LiDAR 130 in FIG. 1). The processor may obtain second raw data through a second sensor (e.g., the camera 140 in FIG. 1). The processor may obtain third raw data through a third sensor (e.g., the RADAR 150 in FIG. 1).

Pieces of first data 701 in FIG. 7 may include first raw data and/or second raw data. Pieces of second data 703 in FIG. 7 may include second raw data and/or third raw data.

In an example, the processor may obtain first object data 711 based on entering the first raw data and the second raw data into a first decoder among a plurality of decoders stored in a memory (e.g., the memory 120 in FIG. 1). For example, the first object data 711 may be expressed in a format of [x_1, y_1, w_1, h_1, cls_1].

In an example, the processor may obtain second object data 713 based on entering the second raw data and the third raw data into a second decoder among the plurality of decoders stored in the memory. For example, the second object data 713 may be expressed in a format of [x_2, y_2, w_2, h_2, cls_2].

For example, [x_1] included in the first object data 711 may mean an x-coordinate of a first location. [y_1] included in the first object data 711 may mean a y-coordinate of the first location. [w_1] included in the first object data 711 may mean a width of a first bounding box. [h_1] included in the first object data 711 may mean a length of the first bounding box. [cls_1] included in the first object data 711 may include the type of an external object identified by a first sensor.

For example, [x_2] included in the second object data 713 may mean an x-coordinate of a second location. [y_2] included in the second object data 713 may mean a y-coordinate of the second location. [w_2] included in the second object data 713 may mean the width of a second bounding box. [h_2] included in the second object data 713 may mean the length of the second bounding box. [cls_2] included in the second object data 713 may include the type of an external object identified by a second sensor.

In an example, the processor may identify the first location indicating a location of the external object included in the first object data. For example, the first location may include coordinates of a center point of the first bounding box corresponding to the external object expressed in a two-dimensional virtual coordinate system.

In an example, the processor may identify the second location indicating a location of the external object included in the second object data. For example, the second location may include coordinates of a center point of the second bounding box corresponding to the external object expressed in a two-dimensional virtual coordinate system.

For example, the processor may obtain an optimal value of a distance between the first location and the second location. The processor may remove false pairs depending on a threshold value based on obtaining the optimal value of the distance between the first location and the second location. For example, the processor may remove false pairs included in at least one of the first object data 711, or the second object data 713, or any combination thereof based on obtaining the optimal value of the distance between the first location and the second location.

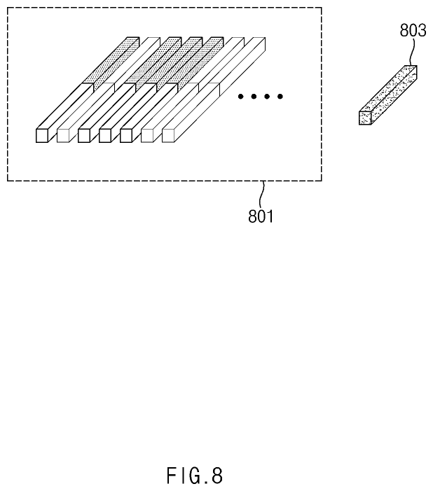

FIG. 8 shows an example of removing data with relatively low reliability, in an example of the present disclosure.

Referring to FIG. 8, a processor (e.g., the processor 110 in FIG. 1) included in a vehicle control apparatus (e.g., the vehicle control apparatus 100 in FIG. 1) according to an example may perform semantic masking process based on the reliability of object data 801. For example, the object data 801 may include first object data obtained by first raw data and second raw data and/or second object data obtained by second raw data and third raw data. The following descriptions may include an example of a semantic masking process performed by the processor.

In an example, the processor may obtain first object data based on entering first sensor data into a first neural network model. The processor may obtain second object data based on entering second sensor data into the first neural network model. The object data 801 described later may include the first object data and the second object data. For example, the object data 801 may be referred to as “prediction data”.

In an example, the processor may identify the reliability of the object data 801. For example, the processor may determine whether the reliability of the object data 801 exceeds a threshold value (e.g., a reference reliability).

For example, the processor may select the object data 801 as input data to be entered into the second neural network model based on the reliability of the object data 801 exceeding the reference reliability.

For example, the processor may remove object data 803, whose reliability is smaller than or equal to reference reliability, from among the object data 801 based on the reliability of the object data 801 being smaller than or equal to the reference reliability. For example, the removed object data 803 may not be entered into the second neural network model.

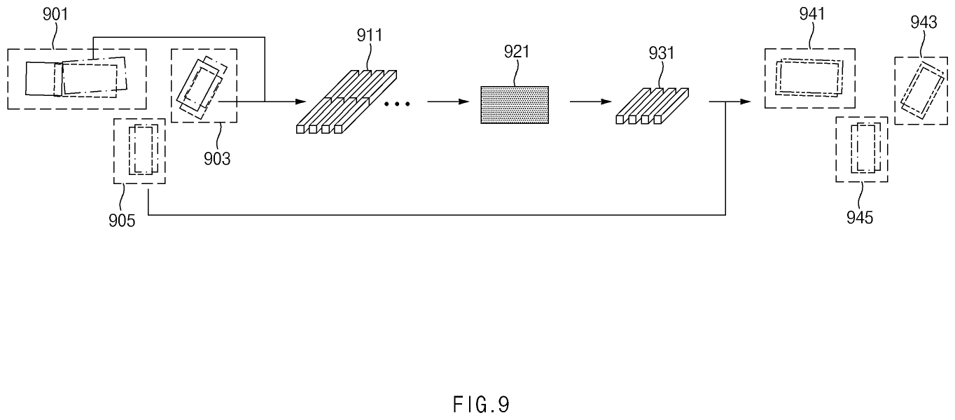

FIG. 9 shows an example of obtaining output data, in an example of the present disclosure.

Referring to FIG. 9, a processor (e.g., the processor 110 in FIG. 1) of a vehicle control apparatus (e.g., the vehicle control apparatus 100 in FIG. 1) according to an example may obtain first raw data through a first sensor (e.g., the LiDAR 130 in FIG. 1). The processor may obtain second raw data through a second sensor (e.g., the camera 140 in FIG. 1). The processor may obtain third raw data through a third sensor (e.g., the RADAR 150 in FIG. 1).

In an example, the processor may obtain first object data based on entering the first raw data and the second raw data into a first decoder. The processor may obtain second object data based on entering the second raw data and the third raw data into a second decoder.

For example, the processor may select at least one of first object data, or second object data, or any combination thereof as input data 911 to be entered into a fourth neural network model 921.

Hereinafter, an example of obtaining output data 931 by entering input data 911 into the fourth neural network model 921 based on selecting at least one of first input data 901, second input data 903, or third input data 905, or any combination thereof as the input data 911 will be described later.

In an example, the processor may select the first input data 901 as the input data 911. For example, the input data 911 may be expressed in a tensor format (e.g., a multi-dimensional array representing images, for example, number of pixels in vertical and/or horizontal directions, color channels, etc.).

For example, the processor may obtain the output data 931 based on entering the first input data 901, which is selected as the input data 911, into the fourth neural network model 921. For example, the output data 931 may be expressed in the tensor format described above. For example, if selecting the first input data 901 as the input data 911, the processor may identify information of pieces of object data included in the first input data 901. For example, the processor may select relatively accurate information from among the information of pieces of object data included in the first input data 901 and may select the selected information as the input data 911. The processor may enter the input data 911 into the fourth neural network model 921 based on selecting the first input data 901 including relatively accurate information as the input data 911.

In an example, the processor may select the second input data 903 as the input data 911.

For example, the processor may obtain the output data 931 based on entering the second input data 903, which is selected as the input data 911, into the fourth neural network model 921. For example, if selecting the second input data 903 as the input data 911, the processor may identify information of pieces of object data included in the second input data 903. For example, the processor may select relatively accurate information from among the information of pieces of object data included in the second input data 903 and may select the selected information as the input data 911. The processor may enter the input data 911 into the fourth neural network model 921 based on selecting the second input data 903 including relatively accurate information as the input data 911.

In an example, the processor may select the third input data 905 as the input data 911.

For example, the processor may obtain the third input data 905 based on removing object data whose reliability is smaller than or equal to reference reliability, from among first object data and second object data. The processor may enter the input data 911 into the fourth neural network model 921 based on selecting the third input data 905 as the input data 911.

In an example, the processor may obtain the output data 931 from the fourth neural network model 921. For example, the output data 931 may be expressed in the tensor format.

For example, the processor may express the output data 931 expressed in the tensor format as a bounding box corresponding to an external object. For example, the processor may obtain a first bounding box 941 based on the first input data 901. For example, the processor may obtain a second bounding box 943 based on the second input data 903. For example, the processor may obtain a third bounding box 945 based on the third input data 905.

For example, the first bounding box 941 and the second bounding box 943 may include a bounding box precisely predicted by selecting information with relatively high accuracy from among various pieces of information.

For example, the third bounding box 945 may include an example of outputting final prediction data based on prediction data from a sensor with high reliability.

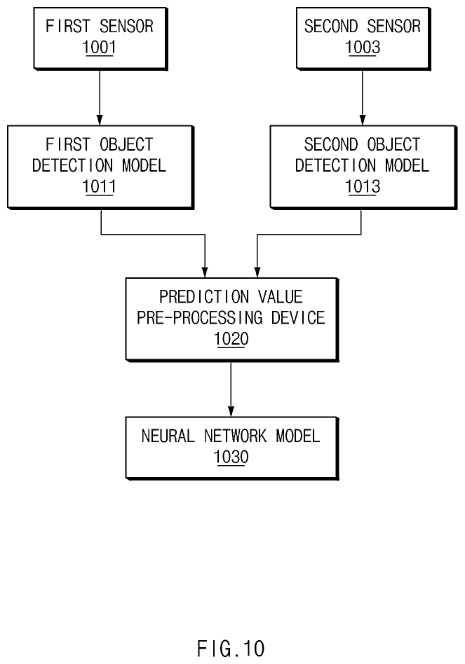

FIG. 10 shows an example of outputting output data, in an example of the present disclosure.

Referring to FIG. 10, a processor (e.g., the processor 110 in FIG. 1) of a vehicle control apparatus (e.g., the vehicle control apparatus 100 in FIG. 1) according to an example may obtain first raw data through a LiDAR (e.g., the LiDAR 130 in FIG. 1). The processor may obtain second raw data through a camera (e.g., the camera 140 in FIG. 1). The processor may obtain third raw data through RADAR (e.g., the RADAR 150 in FIG. 1).

In an example, the processor may enter first sensor data 1001 into a first object detection model 1011. The processor may enter second sensor data 1003 into a second object detection model 1013.

For example, the first sensor data 1001 may include first raw data and second raw data. For example, the second sensor data 1003 may include the second raw data and third raw data.

For example, the first object detection model 1011 and/or the second object detection model 1013 may be included in a plurality of decoders described in FIG. 1. Each of the first object detection model 1011 and/or the second object detection model 1013 may be a neural network model (or a decoder), and may include a model for identifying at least one of a location of an external object, the type of the external object, a heading direction corresponding to a traveling direction of the external object, or a speed of the external object, or any combination thereof.

In an example, the processor may obtain first object data from the first object detection model 1011. The processor may obtain second object data from the second object detection model 1013. For example, the first object data may include data obtained by processing the first sensor data 1001. For example, the second object data may include data obtained by processing the second sensor data 1003.

For example, the first object data, and/or the second object data may include a prediction value for predicting at least one of the location of the external object, the type of the external object, the heading direction corresponding to the traveling direction of the external object, or the speed of the external object, or any combination thereof.

In an example, the processor may enter the first object data and the second object data into a prediction value pre-processing device 1020. For example, the prediction value pre-processing device 1020 may include a device for selecting input data to be entered into a neural network model 1030 based on at least one of a distance between a first location of the external object included in the first object data and a second location of the external object included in the second object data, or the reliability of each of the first object data and the second object data, or any combination thereof. For example, the neural network model 1030 may include the fourth neural network model described in FIG. 1.

In an example, the processor may enter at least one of the first object data, or the second object data, or any combination thereof, which is selected as the selected input data, into the neural network model 1030 based on the prediction value pre-processing device 1020.

For example, the processor may obtain output data 1040 based on input data into the neural network model 1030. For example, the output data 1040 may include at least one of a final bounding box corresponding to the external object, a final location corresponding to a location of the external object, a final type corresponding to the type of the external object, a final heading direction corresponding to the traveling direction of the external object, or a final speed corresponding to the speed of the external object, or any combination thereof.

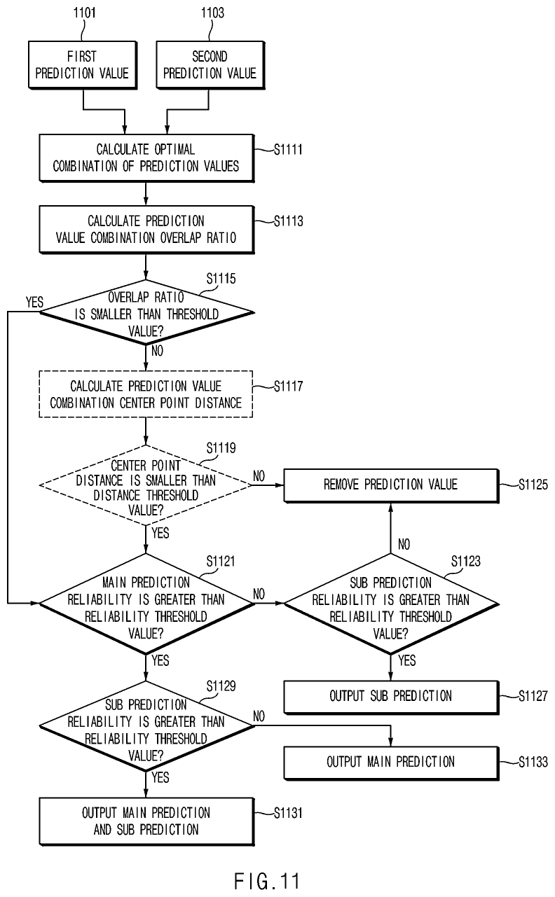

FIG. 11 shows an example associated with a flowchart of a vehicle control method, according to an example of the present disclosure.

Hereinafter, it is assumed that the vehicle control apparatus 100 of FIG. 1 performs the process of FIG. 11. In addition, in a description of FIG. 11, it may be understood that an operation described as being performed by an apparatus is controlled by the processor 110 of the vehicle control apparatus 100.

At least one of operations of FIG. 11 may be performed by the vehicle control apparatus 100 of FIG. 1. Each of the operations in FIG. 11 may be performed sequentially, but is not necessarily sequentially performed. For example, the order of operations may be changed, and at least two operations may be performed in parallel.

Referring to FIG. 11, a vehicle control method according to one example may include an operation of obtaining a first prediction value 1101 and a second prediction value 1103. For example, the first prediction value 1101 may be referred to as the first object data described in FIG. 1. For example, the second prediction value 1103 may be referred to as the second object data described in FIG. 1.

In operation S1111, the vehicle control method according to an example may include an operation of calculating an optimal combination of prediction values. For example, the vehicle control method may include an operation of calculating the optimal combination based on pieces of information included in the prediction values.

In operation S1113, the vehicle control method according to an example may include an operation of calculating a prediction value combination overlap ratio. For example, the vehicle control method may include an operation of calculating a ratio at which a first bounding box generated by the first prediction value 1101 overlaps a second bounding box generated by the second prediction value 1103.

In operation S1115, the vehicle control method according to an example may include an operation of determining whether the overlap ratio is smaller than a threshold value. For example, the overlap ratio may include a ratio, at which the first bounding box overlaps the second bounding box and which is calculated in operation S1113.

If the overlap ratio is not smaller than a threshold value (No in operation S1115), in operation S1117, the vehicle control method according to an example may include an operation of calculating a prediction value combination center point distance. For example, the vehicle control method may include an operation of identifying a distance between a first center point of the first bounding box generated by the first prediction value 1101 and a second center point of the second bounding box generated by the second prediction value 1103.

In operation S1119, the vehicle control method according to an example may include an operation of determining whether the center point distance is smaller than a distance threshold value. For example, the vehicle control method may include an operation of determining whether the distance between the first center point and the second center point identified in operation S1117 is smaller than the distance threshold value.

According to an example, operation S1117 and operation S1119 may be omitted.

If the overlap ratio is smaller than the threshold value (Yes in operation S1115), in operation S1121, the vehicle control method according to an example may include an operation of determining whether main prediction reliability is greater than a reliability threshold value. For example, the main prediction reliability may include the reliability of a prediction value, whose reliability is set to be relatively high, from among the first reliability of the first prediction value 1101 and the second reliability of the second prediction value 1103.

If the main prediction reliability is not greater than the reliability threshold value (No in operation S1121), in operation S1123, the vehicle control method according to an example may include an operation of determining whether sub prediction reliability is greater than the reliability threshold value. For example, the sub prediction reliability may include the reliability of a prediction value, whose reliability is set to be relatively low, from among the first reliability of the first prediction value 1101 and the second reliability of the second prediction value 1103.

If the center point distance is not smaller than the distance threshold value (No in operation S1119), or the sub prediction reliability is not greater than the reliability threshold value (No in operation S1123), in operation S1125, the vehicle control method according to an example may include an operation of removing a prediction value. If the prediction value is removed, the vehicle control method may include an operation of outputting a prediction value corresponding to an external object by using a prediction value obtained at a second time point before the first time point at which the prediction value was obtained. For another example, if the prediction value is removed, the vehicle control method may output the third prediction value described above by using the third prediction value that is different from the first prediction value 1101 and the second prediction value 1103.

If the sub prediction reliability is greater than the reliability threshold value (Yes in operation S1123), in operation S1127, the vehicle control method according to an example may include an operation of outputting sub prediction. For example, if the main prediction reliability is not greater than the reliability threshold value and the sub prediction reliability is greater than the reliability threshold value, the vehicle control method may include an operation of not outputting main prediction, but outputting the sub prediction.

If the main prediction reliability is greater than the reliability threshold value (Yes in operation S1121), in operation S1129, the vehicle control method according to an example may include an operation of determining whether sub prediction reliability is greater than the reliability threshold value. Operation S1129 may be substantially the same as operation S1123.

If the sub prediction reliability is greater than the reliability threshold value (Yes in operation S1129), in operation S1131, the vehicle control method according to an example may include an operation of outputting the main prediction and the sub prediction. For example, if both the main prediction reliability and the sub prediction reliability are greater than the reliability threshold value, the vehicle control method may include an operation of outputting the main prediction and the sub prediction.

If the sub prediction reliability is not greater than the reliability threshold value (No in operation S1129), in operation S1133, the vehicle control method according to an example may include an operation of outputting the main prediction. For example, if the main prediction reliability is greater than the reliability threshold value and the sub prediction reliability is not greater than the reliability threshold value, the vehicle control method may include an operation of not outputting the sub prediction, but outputting the main prediction.

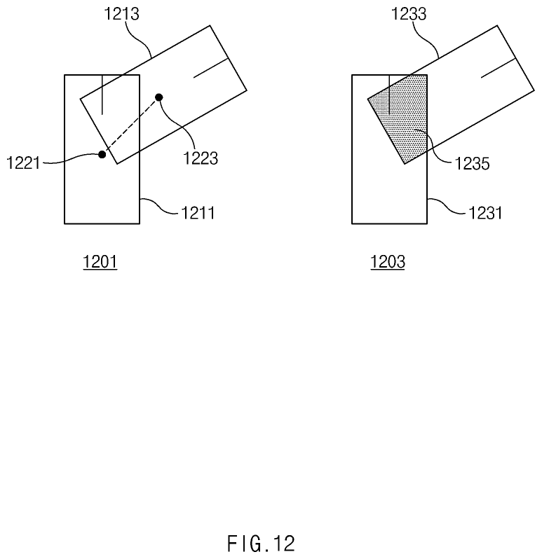

FIG. 12 shows an example of a process using a distance between center points of bounding boxes, or an area in which bounding boxes overlap each other, in an example of the present disclosure.

Referring to FIG. 12, a processor (e.g., the processor 110 in FIG. 1) of a vehicle control apparatus (e.g., the vehicle control apparatus 100 of FIG. 1) according to an example may obtain first object data and/or second object data based on a plurality of decoders.

A first example 1201 in FIG. 12 may include an example of identifying a distance between a first center point of a first bounding box 1211 generated by the first object data and a second center point of a second bounding box 1213 generated by the second object data.

A second example 1203 in FIG. 12 may include an example of identifying an area where a third bounding box 1231 created by the first object data overlaps a fourth bounding box 1233 created by the second object data.

Referring to the first example 1201 in FIG. 12, in an example, the processor may identify a first center point 1221 of the first bounding box 1211. For example, the processor may identify a second center point 1223 of the second bounding box 1213.

For example, the processor may identify a distance between the first center point 1221 and the second center point 1223. For example, the processor may select at least one of the first object data, or the second object data, or any combination thereof as input data to be entered into a second neural network model based on identifying the distance between the first center point 1221 and the second center point 1223.

Referring to the second example 1203 in FIG. 12, in an example, the processor may identify the third bounding box 1231 and the fourth bounding box 1233. For example, the third bounding box 1231 may be substantially the same as the first bounding box 1211. For example, the fourth bounding box 1233 may be substantially the same as the second bounding box 1213.

In an example, the processor may identify an area 1235 where the third bounding box 1231 overlaps the fourth bounding box 1233. For example, the processor may identify the ratio of the area 1235 where the third bounding box 1231 overlaps the fourth bounding box 1233.

$${L}_{Box} = 1 - \vert \frac{{box}_{A} ⋂ {box}_{B}}{{box}_{A} ⋃ {box}_{B}} \vert \qquad [ Equation 1 ]$$

For example, in Equation 1, box_{A} ∪box_{B} may mean the sum of a first area of the third bounding box 1231 and a second area of the fourth bounding box 1233. In Equation 1, box_{A} ∩box_{B} may mean the area 1235 where the third bounding box 1231 overlaps the fourth bounding box 1233. L_{Box} may include a result value for training a second neural network model.

In an example, the processor may train the second neural network model based on the result value for training the second neural network model obtained in Equation 1.

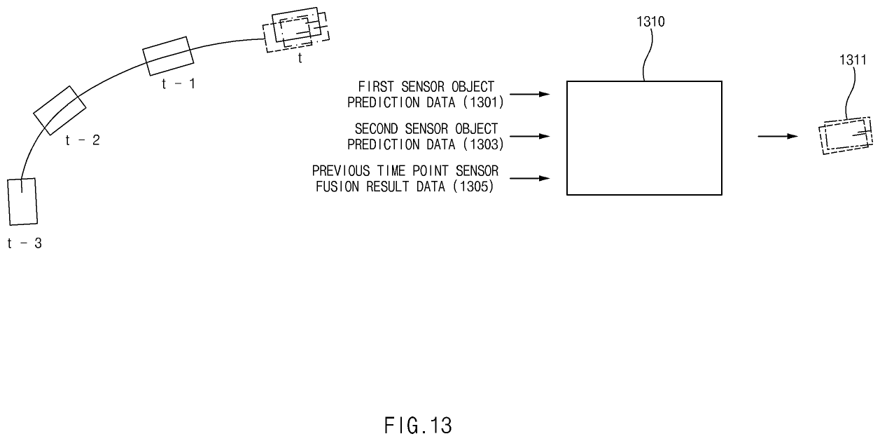

FIG. 13 shows an example of creating a bounding box corresponding to an external object by using data of a first time point and data of a second time point before the first time point, in an example of the present disclosure.

Referring to FIG. 13, a processor (e.g., the processor 110 in FIG. 1) of a vehicle control apparatus (e.g., the vehicle control apparatus 100 in FIG. 1) according to an example may obtain first object data and second object data based on first raw data obtained through a LiDAR (e.g., the LiDAR 130 in FIG. 1), second raw data obtained through a camera (e.g., the camera 140 in FIG. 1), and third raw data obtained through RADAR (e.g., the RADAR 150 in FIG. 1). Hereinafter, the first object data may be referred to as “first sensor object prediction data 1301”. The second object data may be referred to as “second sensor object prediction data 1303”.

For example, the first sensor object prediction data 1301 and the second sensor object prediction data 1303 may include data based on sensor data obtained at time point t.

In an example, the processor may identify previous time point sensor fusion result data 1305. For example, as shown in an example in FIG. 13, the previous time point sensor fusion result data 1305 may include sensor fusion result data at each of time point t-3, time point t-2, and time point t-1.

In an example, the processor may enter the first sensor object prediction data 1301, the second sensor object prediction data 1303, and the previous time point sensor fusion result data 1305 into a neural network model 1310. For example, the neural network model 1310 may include the fourth neural network model described in FIG. 1.

In an example, the processor may obtain output data for outputting a bounding box 1311 corresponding to an external object based on entering the first sensor object prediction data 1301, the second sensor object prediction data 1303, and the previous time point sensor fusion result data 1305 into the neural network model 1310.

For example, the bounding box 1311 corresponding to the external object may include a bounding box corresponding to the external object identified at time point t.

In an example, the processor may output the bounding box 1311 in response to obtaining output data for outputting the bounding box 1311 corresponding to the external object. For example, the bounding box 1311 may include information associated with at least one of a location corresponding to the external object, a heading direction corresponding to a direction in which the external object is driving, a size of the external object, or a speed of the external object, or any combination thereof.

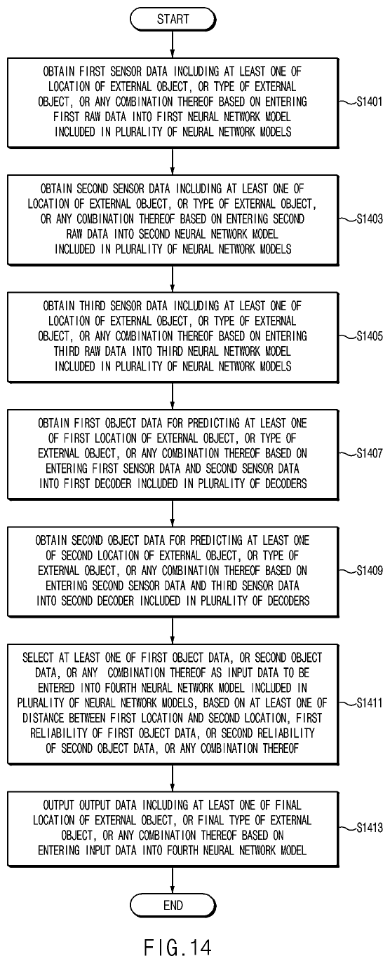

FIG. 14 shows an example of a flowchart associated with a vehicle control method, according to an example of the present disclosure.

Hereinafter, it is assumed that the vehicle control apparatus 100 of FIG. 1 performs the process of FIG. 14. In addition, in a description of FIG. 14, it may be understood that an operation described as being performed by an apparatus is controlled by the processor 110 of the vehicle control apparatus 100.

At least one of operations of FIG. 14 may be performed by the vehicle control apparatus 100 of FIG. 1. Each of the operations in FIG. 14 may be performed sequentially, but is not necessarily sequentially performed. For example, the order of operations may be changed, and at least two operations may be performed in parallel.

Referring to FIG. 14, in operation S1401, a vehicle control method according to an example may include an operation of obtaining first sensor data associated with at least one of a location of an external object, or a type of the external object, or any combination thereof based on entering first raw data into a first neural network model included in a plurality of neural network models. For example, the first sensor data may be obtained based on feature map sampling being performed on a point cloud obtained through a LiDAR.

In operation S1403, the vehicle control method according to an example may include an operation of obtaining second sensor data associated with at least one of a location of an external object, or a type of the external object, or any combination thereof based on entering second raw data into a second neural network model included in a plurality of neural network models. For example, the second sensor data may be obtained based on feature map sampling being performed on pixels included in the image obtained through a camera.

In operation S1405, the vehicle control method according to an example may include an operation of obtaining third sensor data associated with at least one of a location of an external object, or a type of the external object, or any combination thereof based on entering third raw data into a third neural network model included in a plurality of neural network models. For example, the third sensor data may be obtained based on the fact that the feature map sampling is performed on optical signals obtained through RADAR.

In operation S1407, the vehicle control method according to an example may include an operation of obtaining first object data for predicting at least one of a first location of the external object, or the type of the external object, or any combination thereof based on entering the first sensor data and the second sensor data into a first decoder included in a plurality of decoders.

In operation S1409, the vehicle control method according to an example may include an operation of obtaining second object data for predicting at least one of a second location of the external object, or the type of the external object, or any combination thereof based on entering the second sensor data and the third sensor data into a second decoder included in the plurality of decoders.

In operation S1411, the vehicle control method according to an example may include an operation of selecting at least one of the first object data, or the second object data, or any combination thereof as input data to be entered into a fourth neural network model included in the plurality of neural network models, based on at least one of a distance between the first location and the second location, first reliability of the first object data, or second reliability of the second object data, or any combination thereof.

The vehicle control method according to an example may include an operation of selecting at least one of the first object data, or the second object data, or any combination thereof as input data based on whether the first reliability and the second reliability exceed reference reliability.

The vehicle control method according to an example may include an operation of identifying or determining a first location, which is generated by the first object data and which indicates the center point of the first bounding box corresponding to the external object. For example, the vehicle control method may include an operation of identifying or determining the second location, which is generated by the second object data and which indicates a center point of a second bounding box corresponding to the external object. For example, the vehicle control method may include an operation of selecting at least one of the first object data, or the second object data, or any combination thereof as input data based on whether the distance between the first location and the second location exceeds the reference distance.

In operation S1413, the vehicle control method according to an example may include an operation of outputting output data including at least one of a final location of the external object, or a final type of the external object, or any combination thereof based on entering input data into the fourth neural network model.

The vehicle control method according to an example may include an operation of identifying or determining a first maximum distance between a first point cloud and a LiDAR based on obtaining the first raw data including the first point cloud through the LiDAR. For example, the vehicle control method may include an operation of obtaining a second intensity value in a foggy state based on at least one of the first maximum distance between the first point cloud and the LiDAR, a weight indicating the foggy state, or a first intensity value in a clear state, or any combination thereof.

The vehicle control method according to an example may include an operation of identifying or determining a second maximum distance of the LiDAR capable of identifying the external object in the foggy state based on the weight indicating the foggy state. For example, the vehicle control method may include an operation of identifying or determining a third intensity value indicating the degree of scattering by fog based on the second maximum distance, the weight indicating a foggy state, and the first intensity value in a clear state. For example, the vehicle control method may include an operation of obtaining a second point cloud scattered by the fog based on the first point cloud, the second maximum distance, and the first maximum distance. For example, the vehicle control method may include an operation of training at least one of the plurality of neural network models by using the second point cloud.

In an example, the second raw data may include a light permeability, an airglow, and first pixel values for forming an image obtained through a camera.

The vehicle control method according to an example may include an operation of generating the second pixel values associated with the image in a foggy state based on the light permeability, the airglow, and the first pixel values. For example, the vehicle control method may include an operation of training at least one of the plurality of neural network models by using a virtual image formed by the second pixel values.

The vehicle control method according to an example may include obtaining the light permeability based on a depth map pixel value and a weight indicating the foggy state.

As mentioned above, the vehicle control method according to an example may include accurately identifying or determining at least one of the final location of the external object, or the final type of the external object, or any combination thereof by identifying or determining at least one of the final location of the external object, or the final type of the external object, or any combination thereof based on using a plurality of neural network models.

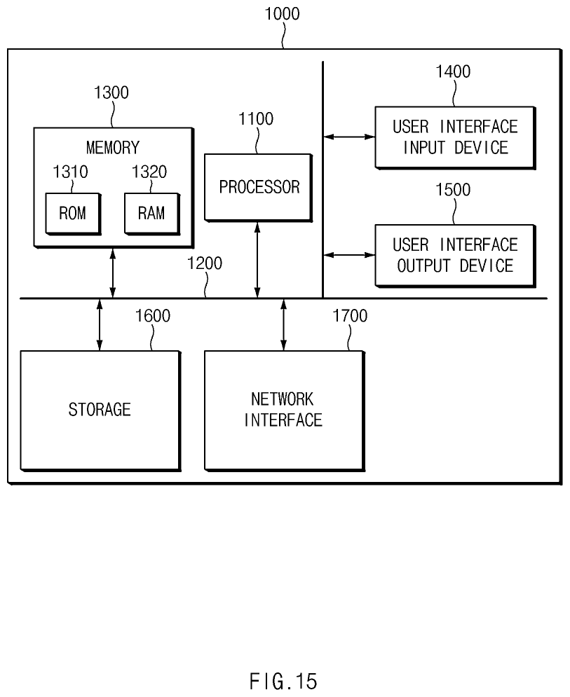

FIG. 15 shows a computing system associated with a vehicle control apparatus or vehicle control method, according to an example of the present disclosure.

Referring to FIG. 15, a computing system 1000 may include at least one processor 1100, a memory 1300, a user interface input device 1400, a user interface output device 1500, storage 1600, and a network interface 1700, which are connected with each other via a bus 1200.

The processor 1100 may be a central processing device (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Accordingly, the processes of the method or algorithm described in relation to the examples of the present disclosure may be implemented directly by hardware executed by the processor 1100, a software module, or a combination thereof. The software module may reside in a storage medium (that is, the memory 1300 and/or the storage 1600), such as a RAM, a flash memory, a ROM, an EPROM, an EEPROM, a register, a hard disk, solid state drive (SSD), a detachable disk, or a CD-ROM. The exemplary storage medium is coupled to the processor 1100, and the processor 1100 may read information from the storage medium and may write information in the storage medium. In another method, the storage medium may be integrated with the processor 1100. The processor 1100 and the storage medium may reside in an application specific integrated circuit (ASIC). The ASIC may reside in a user terminal. In another method, the processor 1100 and the storage medium may reside in the user terminal as an individual component.

The present disclosure is made to solve the above-mentioned problems occurring in the prior art while advantages achieved by the prior art are maintained intact.

An example of the present disclosure provides a vehicle control apparatus that accurately detects an external object by using sensor data obtained by various sensors, and a method thereof.

An example of the present disclosure provides a vehicle control apparatus that accurately detects the external object by identifying or determining the external object based on entering pieces of sensor data into a neural network model, and a method thereof.

An example of the present disclosure provides a vehicle control apparatus that accurately detects the external object under various conditions by detecting the external object by using various neural network models, and a method thereof.

The technical problems to be solved by the present disclosure are not limited to the aforementioned problems, and any other technical problems not mentioned herein will be clearly understood from the following description by those skilled in the art to which the present disclosure pertains.

According to an example of the present disclosure, a vehicle control apparatus may include a light detection and ranging (LiDAR) that obtains first raw data based on identifying an external object, a camera that obtains second raw data based on identifying or determining the external object, a radio detection and ranging (RADAR) that obtains third raw data based on identifying or determining the external object, a memory that stores a plurality of neural network models and a plurality of decoders, and a processor. The processor may obtain first sensor data associated with at least one of a location of the external object, or a type of the external object, or any combination thereof based on entering the first raw data into a first neural network model included in the plurality of neural network models, may obtain second sensor data associated with at least one of the location of the external object, or the type of the external object, or any combination thereof based on entering the second raw data into a second neural network model included in the plurality of neural network models, may obtain third sensor data associated with at least one of the location of the external object, or the type of the external object, or any combination thereof based on entering the third raw data into a third neural network model included in the plurality of neural network models, may obtain first object data for predicting at least one of a first location of the external object, or the type of the external object, or any combination thereof based on entering the first sensor data and the second sensor data into a first decoder included in the plurality of decoders, may obtain second object data for predicting at least one of a second location of the external object, or the type of the external object, or any combination thereof based on entering the second sensor data and the third sensor data into a second decoder included in the plurality of decoders, may select at least one of the first object data, or the second object data, or any combination thereof as input data to be entered into a fourth neural network model included in the plurality of neural network models, based on at least one of a distance between the first location and the second location, first reliability of the first object data, or second reliability of the second object data, or any combination thereof, and may output output data including at least one of a final location of the external object, or a final type of the external object, or any combination thereof based on entering the input data into the fourth neural network model.

In an example, the first sensor data may be obtained based on feature map sampling being performed on a point cloud obtained through the LiDAR.

In an example, the second sensor data may be obtained based on feature map sampling being performed on pixels included in an image obtained through the camera.

In an example, the third sensor data may be obtained based on feature map sampling performed on optical signals obtained through the RADAR.

In an example, the processor may identify a first maximum distance between a first point cloud and the LiDAR based on obtaining the first raw data including the first point cloud through the LiDAR, and may obtain a second intensity value in a foggy state based on at least one of the first maximum distance between the first point cloud and the LiDAR, a weight indicating the foggy state, or a first intensity value in a clear state, or any combination thereof.

In an example, the processor may identify or determine a second maximum distance of the LiDAR capable of identifying the external object in the foggy state based on the weight indicating the foggy state, may identify or determine a third intensity value indicating a degree of scattering by fog based on the second maximum distance, the weight, and the first intensity value in the clear state, may obtain a second point cloud scattered by the fog based on the first point cloud, the second maximum distance, and the first maximum distance, and may train at least one of the plurality of neural network models by using the second point cloud.

In an example, the second raw data may include a light permeability, an airglow, and first pixel values for forming an image obtained through the camera. The processor may generate second pixel values associated with an image in a foggy state based on the light permeability, the airglow, and the first pixel values, and may train at least one of the plurality of neural network models by using a virtual image formed by the second pixel values.

In an example, the processor may obtain the light permeability based on a depth map pixel value and a weight indicating the foggy state.

In an example, the processor may select at least one of the first object data, or the second object data, or any combination thereof as the input data based on whether the first reliability and the second reliability exceed reference reliability.

In an example, the processor may identify or determine the first location, which is generated by the first object data and which indicates a center point of a first bounding box corresponding to the external object, may identify or determine the second location, which is generated by the second object data and which indicates a center point of a second bounding box corresponding to the external object, and may select at least one of the first object data, or the second object data, or any combination thereof as the input data based on whether a distance between the first location and the second location exceeds a reference distance.

According to an example of the present disclosure, a vehicle control method may include obtaining first sensor data associated with at least one of a location of an external object, or a type of the external object, or any combination thereof based on entering first raw data, which is obtained based on identifying or determining the external object through a LiDAR, into a first neural network model included in a plurality of neural network models stored in a memory, obtaining second sensor data associated with at least one of the location of the external object, or the type of the external object, or any combination thereof based on entering second raw data, which is obtained based on identifying or determining the external object through a camera, into a second neural network model included in the plurality of neural network models, obtaining third sensor data associated with at least one of the location of the external object, or the type of the external object, or any combination thereof based on entering third raw data, which is obtained based on identifying or determining the external object through a RADAR, into a third neural network model included in the plurality of neural network models, obtaining first object data for predicting at least one of a first location of the external object, or the type of the external object, or any combination thereof based on entering the first sensor data and the second sensor data into a first decoder included in a plurality of decoders, obtaining second object data for predicting at least one of a second location of the external object, or the type of the external object, or any combination thereof based on entering the second sensor data and the third sensor data into a second decoder included in the plurality of decoders, selecting at least one of the first object data, or the second object data, or any combination thereof as input data to be entered into a fourth neural network model included in the plurality of neural network models, based on at least one of a distance between the first location and the second location, first reliability of the first object data, or second reliability of the second object data, or any combination thereof, and outputting output data including at least one of a final location of the external object, or a final type of the external object, or any combination thereof based on entering the input data into the fourth neural network model.

In an example, the first sensor data may be obtained based on feature map sampling being performed on a point cloud obtained through the LiDAR.

In an example, the second sensor data may be obtained based on feature map sampling being performed on pixels included in an image obtained through the camera.

In an example, the third sensor data may be obtained based on feature map sampling performed on optical signals obtained through the RADAR.

According to an example, the vehicle control method may further include identifying a first maximum distance between a first point cloud and the LiDAR based on obtaining the first raw data including the first point cloud through the LiDAR, and obtaining a second intensity value in a foggy state based on at least one of the first maximum distance between the first point cloud and the LiDAR, a weight indicating the foggy state, or a first intensity value in a clear state, or any combination thereof.

According to an example, the vehicle control method may further include identifying a second maximum distance of the LiDAR capable of identifying or determining the external object in the foggy state based on the weight indicating the foggy state, identifying or determining a third intensity value indicating a degree of scattering by fog based on the second maximum distance, the weight, and the first intensity value in the clear state, obtaining a second point cloud scattered by the fog based on the first point cloud, the second maximum distance, and the first maximum distance, and training at least one of the plurality of neural network models by using the second point cloud.

In an example, the second raw data may include a light permeability, an airglow, and first pixel values for forming an image obtained through the camera. The vehicle control method may further include generating second pixel values associated with an image in a foggy state based on the light permeability, the airglow, and the first pixel values, and training at least one of the plurality of neural network models by using a virtual image formed by the second pixel values.

According to an example, the vehicle control method may further include obtaining the light permeability based on a depth map pixel value and a weight indicating the foggy state.

According to an example, the vehicle control method may further include selecting at least one of the first object data, or the second object data, or any combination thereof as the input data based on whether the first reliability and the second reliability exceed reference reliability.

According to an example, the vehicle control method may further include identifying the first location, which is generated by the first object data and which indicates a center point of a first bounding box corresponding to the external object, identifying or determining the second location, which is generated by the second object data and which indicates a center point of a second bounding box corresponding to the external object, and selecting at least one of the first object data, or the second object data, or any combination thereof as the input data based on whether a distance between the first location and the second location exceeds a reference distance.

Hereinabove, although the present disclosure has been described with reference to examples and the accompanying drawings, the present disclosure is not limited thereto, but may be variously modified and altered by those skilled in the art to which the present disclosure pertains without departing from the spirit and scope of the present disclosure claimed in the following claims.

Therefore, the examples of the present disclosure are provided to explain the spirit and scope of the present disclosure, but not to limit them, so that the spirit and scope of the present disclosure is not limited by the examples. The scope of the present disclosure should be construed on the basis of the accompanying claims, and all the technical ideas within the scope equivalent to the claims should be included in the scope of the present disclosure.

The present technology may accurately detect an external object by using sensor data obtained by various sensors.

Moreover, the present technology may accurately detect the external object by identifying or determining the external object based on entering pieces of sensor data into a neural network model.

Furthermore, the present technology may accurately detect the external object under various conditions by detecting the external object by using various neural network models.

Besides, a variety of effects directly or indirectly understood through the specification may be provided.

Hereinabove, although the present disclosure is described with reference to examples and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. An apparatus for controlling a vehicle, the apparatus comprising:
a first sensor configured to obtain, based on identifying an external object, first raw data;
a second sensor configured to obtain, based on identifying the external object, second raw data;
a third sensor configured to obtain, based on identifying the external object, third raw data;
a memory configured to store a plurality of neural network models and a plurality of decoders; and
a processor configured to:
obtain, based on entering the first raw data into a first neural network model of the plurality of neural network models, first sensor data associated with at least one of a location of the external object or a type of the external object;
obtain, based on entering the second raw data into a second neural network model of the plurality of neural network models, second sensor data associated with at least one of the location of the external object or the type of the external object;
obtain, based on entering the third raw data into a third neural network model of the plurality of neural network models, third sensor data associated with at least one of the location of the external object or the type of the external object;
obtain, based on entering the first sensor data and the second sensor data into a first decoder of the plurality of decoders, first object data for predicting at least one of a first location of the external object or the type of the external object;
obtain, based on entering the second sensor data and the third sensor data into a second decoder of the plurality of decoders, second object data for predicting at least one of a second location of the external object or the type of the external object;
select at least one of the first object data or the second object data as input data, based on at least one of a distance between the first location and the second location, a first reliability value of the first object data, or a second reliability value of the second object data, wherein the input data is entered into a fourth neural network model of the plurality of neural network models;
output, based on entering the input data into the fourth neural network model, data including at least one of a final location of the external object or a final type of the external object; and
control, based on the data, operation of the vehicle.

2. The apparatus of claim 1, wherein the first sensor data is obtained based on feature map sampling being performed on a cluster of points, wherein the cluster of points is obtained through the first sensor, and wherein the first sensor comprises a light detection and ranging (LiDAR) device.

3. The apparatus of claim 1, wherein the second sensor data is obtained based on feature map sampling being performed on pixels included in an image, wherein the image is obtained through the second sensor, and wherein the second sensor comprises a camera.

4. The apparatus of claim 1, wherein the third sensor data is obtained based on feature map sampling performed on optical signals, wherein the optical signals are obtained through the third sensor, and wherein the third sensor comprises a radio detection and ranging (RADAR) device.

5. The apparatus of claim 1, wherein the processor is configured to:
determine, based on obtaining the first raw data, a first maximum distance between a first cluster of points and the first sensor, wherein the first raw data comprises the first cluster of points; and
obtain a second intensity value in a foggy state based on at least one of:
the first maximum distance between the first cluster of points and the first sensor,
a weight indicating the foggy state, or
a first intensity value in a clear state.

6. The apparatus of claim 5, wherein the processor is configured to:
determine, based on the weight indicating the foggy state, a second maximum distance that the first sensor is capable of identifying the external object in the foggy state;
determine, based on the second maximum distance, the weight, and the first intensity value, a third intensity value indicating a degree of scattering by fog;
obtain, based on the first cluster of points, the first maximum distance, and the second maximum distance, a second cluster of points scattered by the fog; and
train, based on the second cluster of points, at least one of the plurality of neural network models.

7. The apparatus of claim 1, wherein the second raw data includes a light permeability, an airglow, and first pixel values for forming an image obtained through the second sensor, and
wherein the processor is configured to:
generate, based on the light permeability, the airglow, and the first pixel values, second pixel values associated with an image in a foggy state; and
train, based on a virtual image formed by the second pixel values, at least one of the plurality of neural network models.

8. The apparatus of claim 7, wherein the processor is configured to:
obtain, based on a depth map pixel value and a weight indicating the foggy state, the light permeability.

9. The apparatus of claim 1, wherein the processor is configured to:
select, based on whether the first reliability value and the second reliability value exceed a reference reliability value, at least one of the first object data or the second object data as the input data.

10. The apparatus of claim 1, wherein the processor is configured to:
determine the first location, wherein the first location is generated by the first object data and the first location indicates a center point of a first bounding box corresponding to the external object;
determine the second location, wherein the second location is generated by the second object data and the second location indicates a center point of a second bounding box corresponding to the external object; and
select, based on whether the distance between the first location and the second location exceeds a reference distance, at least one of the first object data or the second object data as the input data.

11. A method performed by a processor for controlling a vehicle, the method comprising:
obtaining, based on entering a first raw data into a first neural network model of a plurality of neural network models stored in a memory, first sensor data associated with at least one of a location of an external object or a type of the external object, wherein the first raw data is obtained based on identifying the external object through a first sensor;
obtaining, based on entering the second raw data into a second neural network model of the plurality of neural network models, second sensor data associated with at least one of the location of the external object or the type of the external object, wherein the second raw data is obtained based on identifying the external object through a second sensor;
obtaining, based on entering the third raw data into a third neural network model of the plurality of neural network models, third sensor data associated with at least one of the location of the external object or the type of the external object, wherein the third raw data is obtained based on identifying the external object through a third sensor;
obtaining, based on entering the first sensor data and the second sensor data into a first decoder of the plurality of decoders, first object data for predicting at least one of a first location of the external object or the type of the external object;
obtaining, based on entering the second sensor data and the third sensor data into a second decoder of the plurality of decoders, second object data for predicting at least one of a second location of the external object or the type of the external object;
selecting at least one of the first object data or the second object data as input data, based on at least one of a distance between the first location and the second location, a first reliability value of the first object data, or a second reliability value of the second object data, wherein the input data is entered into a fourth neural network model of the plurality of neural network models; and
outputting, based on entering the input data into the fourth neural network model, data including at least one of a final location of the external object or a final type of the external object; and
controlling, based on the data, operation of the vehicle.

12. The method of claim 11, wherein the first sensor data is obtained based on feature map sampling being performed on a cluster of points, wherein the cluster of points is obtained through the first sensor, and wherein the first sensor comprises a light detection and ranging (LiDAR) device.

13. The method of claim 11, wherein the second sensor data is obtained based on feature map sampling being performed on pixels of an image, wherein the image is obtained through the second sensor, and wherein the second sensor comprises a camera.

14. The method of claim 11, wherein the third sensor data is obtained based on feature map sampling performed on optical signals, wherein the optical signals are obtained through the third sensor, and wherein the third sensor comprises a radio detection and ranging (RADAR) device.

15. The method of claim 11, further comprising:
determining, based on obtaining the first raw data, a first maximum distance between a first cluster of points and the first sensor, wherein the first raw data comprises the first cluster of points; and
obtaining a second intensity value in a foggy state based on at least one of:
the first maximum distance between the first cluster of points and the first sensor,
a weight indicating the foggy state, or
a first intensity value in a clear state.

16. The method of claim 15, further comprising:
determining, based on the weight indicating the foggy state, a second maximum distance that the first sensor is capable of identifying the external object in the foggy state;
determining, based on the second maximum distance, the weight, and the first intensity value, a third intensity value indicating a degree of scattering by fog;
obtaining, based on the first cluster of points, the first maximum distance, and the second maximum distance, a second cluster of points scattered by the fog; and
training, based on the second cluster of points, at least one of the plurality of neural network models.

17. The method of claim 11, wherein the second raw data includes a light permeability, an airglow, and first pixel values for forming an image obtained through the second sensor, and
the method further comprising:
generating, based on the light permeability, the airglow, and the first pixel values, second pixel values associated with an image in a foggy state; and
training, based on a virtual image formed by the second pixel values, at least one of the plurality of neural network models.

18. The method of claim 17, further comprising:
obtaining, based on a depth map pixel value and a weight indicating the foggy state, the light permeability.

19. The method of claim 11, further comprising:
selecting, based on whether the first reliability value and the second reliability value exceed a reference reliability value, at least one of the first object data or the second object data.

20. The method of claim 11, further comprising:
determining the first location, wherein the first location is generated by the first object data and the first location indicates a center point of a first bounding box corresponding to the external object;
determining the second location, wherein the second location is generated by the second object data and the second location indicates a center point of a second bounding box corresponding to the external object; and
selecting, based on whether the distance between the first location and the second location exceeds a reference distance, at least one of the first object data or the second object data.
